(19) United States
(12) Patent Application Publication
(10) Pub. No.: US 2026/0295891 A1
(43) Pub. Date: Oct. 1, 2026

(54) CHAINSAW

(71) Applicant: Nanjing Chervon Industry Co., Ltd., Nanjing (CN)

(72) Inventors: Zengbing Guo, Nanjing (CN); Shangsi Chen, Nanjing (CN); Zhaodi Ou, Nanjing (CN); Yang Li, Nanjing (CN); Chengxin Pan, Nanjing (CN)

(21) Appl. No.: 19/236,663

(22) Filed: Jun. 12, 2025

(30) Foreign Application Priority Data
Mar. 25, 2025 (CN) 202510365576.6
Mar. 25, 2025 (CN) 202520535728.8

(51) Int. Cl. B27B 17/08; B27B 17/02

(52) U.S. Cl. CPC B27B 17/083; B27B 17/02

(57) ABSTRACT

A chainsaw includes a housing; an electric motor supported by the housing; a chain driven by the electric motor to perform cutting; a guide plate for supporting and guiding the chain; and a control circuit including a controller and an inverter circuit having multiple switching elements, where the controller is configured to switch the conduction states of the multiple switching elements in the inverter circuit to control the operation of the electric motor. The controller outputs a braking control signal in response to a braking instruction to control the state of the inverter circuit so that the speed of the chain is reduced from the operating chain speed to the braking chain speed, where the maximum value of the operating chain speed is greater than or equal to 16 m/s, and the braking chain speed is less than or equal to 1 m/s.

### RELATED APPLICATION INFORMATION

This application claims the benefit under 35 U.S.C. § 119(a) of Chinese Patent Application No. 202510365576.6, filed on Mar. 25, 2025, and Chinese Patent Application No. 202520535728.8, filed on Mar. 25, 2025, which applications are incorporated herein by reference in their entireties.

### TECHNICAL FIELD

The present application relates to the technical field of power tools, for example, a chainsaw.

### BACKGROUND

A chainsaw is a common handheld garden tool and is widely used with the increase in private and public greening areas. Currently, most chainsaws use electricity as a power source. An electric motor inside a chainsaw may drive a chain to rotate around a guide plate so that the interlaced L-shaped blades on the chain can cut wood or shrub branches. To ensure user safety and experience, the brake design of the chainsaw is a key point.

This part provides background information related to the present application, and the background information is not necessarily the existing art.

### SUMMARY

An object of the present application is to solve or at least alleviate part or all of the preceding problems. Therefore, the present application provides a chainsaw.

To achieve the preceding object, the present application adopts the technical solutions below.

A chainsaw includes a housing; an electric motor supported by the housing; a chain driven by the electric motor to perform cutting; a guide plate for supporting and guiding the chain; and a control circuit including a controller and an inverter circuit having multiple switching elements, where the controller is configured to switch the conduction states of the multiple switching elements in the inverter circuit to control the operation of the electric motor. The controller outputs a braking control signal in response to a braking instruction to control the state of the inverter circuit so that the speed of the chain is reduced from the operating chain speed to the braking chain speed, where the maximum value of the operating chain speed is greater than or equal to 16 m/s, and the braking chain speed is less than or equal to 1 m/s.

In some examples, the maximum value of the operating chain speed is greater than or equal to 20 m/s.

In some examples, the braking duration of the chainsaw is less than or equal to 120 ms.

In some examples, a battery pack for supplying power to at least the electric motor is further included, where during a braking process of the chainsaw, the maximum value of the bus voltage of the electric motor does not exceed 1.65 times the rated voltage of the battery pack, and/or during a braking process of the chainsaw, the maximum value of the bus voltage of the electric motor does not exceed 1.5 times the nominal voltage of the battery pack.

In some examples, a battery pack for supplying power to at least the electric motor is further included, where during a braking process of the chainsaw, the maximum value of the bus voltage of the electric motor does not exceed 1.4 times the rated voltage of the battery pack, and/or during a braking process of the chainsaw, the maximum value of the bus voltage of the electric motor does not exceed 1.3 times the nominal voltage of the battery pack.

In some examples, the chainsaw does not have a mechanical brake mechanism.

In some examples, the braking instruction includes a user operation instruction and a self-detection abnormality instruction.

In some examples, the electric motor is a brushless motor, and the controller controls the state of the inverter circuit in a field-oriented control (FOC) manner.

In some examples, the control circuit further includes a parameter detection device configured to detect a working parameter of the electric motor; and the controller performs closed-loop negative feedback regulation on the bus voltage of the electric motor based on the current working parameter of the electric motor in response to the braking instruction.

In some examples, when the controller performs the closed-loop negative feedback regulation on the bus voltage of the electric motor, one or more of the following boundary conditions are satisfied: the target value of the bus voltage does not exceed the maximum value of the bus voltage allowed by hardware of a battery pack and/or the electric motor; the current actual value of the bus voltage does not exceed the maximum value of the bus voltage allowed by hardware (a battery pack and/or the electric motor); and the target value of the bus voltage is greater than or equal to the current actual value of the bus voltage.

In some examples, when the controller controls the electric motor to operate normally in the FOC manner, at least a current loop as an inner loop and a speed loop as an outer loop are used; and when the controller controls the electric motor to brake in the FOC manner, at least the current loop as the inner loop and a voltage loop as an outer loop are used.

In some examples, when the controller performs closed-loop negative feedback regulation on the current of the electric motor, one or more of the following boundary conditions are satisfied: the target value of the bus current and/or the three-phase current does not exceed the maximum value of the current allowed by hardware of a battery pack and/or the electric motor; and the maximum value of the output power does not exceed the maximum value of the power allowed by at least one hardware among a battery pack, the electric motor, and the chainsaw.

In some examples, when the controller controls the electric motor to brake in the FOC manner, the quadrature-axis (q-axis) target current is set to a negative value relative to the q-axis actual current, and/or the direct-axis (d-axis) target current is set to a negative value relative to the d-axis actual current.

In some examples, a large capacitor or a backup power supply for braking energy recovery is further included.

A chainsaw includes a housing; an electric motor supported by the housing; a chain driven by the electric motor to perform cutting; a guide plate for supporting and guiding the chain; and a control circuit including a controller and an inverter circuit having multiple switching elements, where the controller is configured to switch the conduction states of the multiple switching elements in the inverter circuit to control the operation of the electric motor. The controller outputs a braking control signal in response to a braking instruction to control the state of the inverter circuit so that the chainsaw is braked within 120 ms, and the maximum value of the operating chain speed of the chain is greater than or equal to 16 m/s.

A chainsaw includes a housing; an electric motor supported by the housing; a battery pack for supplying power to at least the electric motor; a chain driven by the electric motor to perform cutting; a guide plate for supporting and guiding the chain; and a control circuit including a controller and an inverter circuit having multiple switching elements, where the controller is configured to switch the conduction states of the multiple switching elements in the inverter circuit to control the operation of the electric motor. The control circuit outputs a braking control signal in response to a braking instruction to control the state of the inverter circuit so that the chainsaw is braked within 120 ms, and the ratio of the maximum value of the bus voltage of the electric motor during braking to the rated voltage of the battery pack is less than or equal to 1.65.

A chainsaw includes a housing; an electric motor supported by the housing; a battery pack for supplying power to at least the electric motor; a chain driven by the electric motor to perform cutting; a guide plate for supporting and guiding the chain; and a control circuit including a controller and an inverter circuit having multiple switching elements, where the controller is configured to switch the conduction states of the multiple switching elements in the inverter circuit to control the operation of the electric motor. The control circuit outputs a braking control signal in response to a braking instruction to control the state of the inverter circuit so that the chainsaw is braked within 120 ms, and the ratio of the maximum value of the bus voltage of the electric motor during braking to the nominal voltage of the battery pack is less than or equal to 1.5.

A chainsaw includes a housing; an electric motor supported by the housing and including a motor shaft and a motor bearing sleeved on the motor shaft; a chain driven by the electric motor to perform cutting; and a guide plate for supporting and guiding the chain. Along the axial direction of the motor shaft, the distance from the motor bearing adjacent to the guide plate to the plane where the guide plate is located is less than or equal to 18 mm.

In some examples, along the axial direction of the motor shaft, the minimum value of the distance from the motor bearing to the plane where the guide plate is located is less than or equal to 18 mm.

In some examples, the chainsaw does not have an oil pump or an oil pump in an oil pump assembly is not between the guide plate and the motor bearing.

In some examples, the motor shaft directly drives a sprocket.

In some examples, the chainsaw does not have a mechanical brake mechanism.

In some examples, a brake baffle rotatably connected to the housing is further included, where the mass of the brake baffle is less than or equal to 70 g.

In some examples, a brake baffle rotatably connected to the housing is further included, where the distance between the projection of the rotation axis of the brake baffle on a first plane and the projection of the rotation axis of the motor shaft on the first plane is less than or equal to 55 mm, where the first plane is perpendicular to the rotation axis of the motor shaft.

In some examples, a brake baffle and a tensioning assembly are further included, where the brake baffle is rotatably connected to the housing, and the tensioning assembly includes a tensioning operating member operable by a user to adjust the tension of the chain around the outer periphery of the guide plate; and a guide plate centerline is used as a horizontal coordinate axis, the projection of the rotation axis of the brake baffle on the plane where the guide plate is located is defined as a vertical coordinate axis, and the tensioning operating member is located in the second quadrant of a coordinate system formed by the horizontal coordinate axis and the vertical coordinate axis.

In some examples, an illumination assembly is further included, and the illumination assembly is located in the first quadrant of the coordinate system.

A chainsaw includes a housing; an electric motor supported by the housing and including a motor shaft and a motor bearing sleeved on the motor shaft; a chain driven by the electric motor to perform cutting; a guide plate for supporting and guiding the chain; and a guard rotatably connected to the housing. The chainsaw further includes an oil pump assembly at least partially disposed on a side of the motor bearing facing the guide plate. Along the axial direction of the motor shaft, the distance from the motor bearing adjacent to the guide plate to the plane where the guide plate is located is less than or equal to 30 mm.

In some examples, the oil pump in the oil pump assembly is located between the motor bearing and the guide plate.

### BRIEF DESCRIPTION OF THE DRAWINGS

FIG. 1 is a schematic view of a chainsaw as an example of the present application.

FIG. 2 is a plan view of some internal structures of a chainsaw with a side cover removed according to an example.

FIG. 3A is a perspective view of a mechanical brake mechanism of a chainsaw in the related art according to an example.

FIG. 3B is a plan view of some internal structures of a chainsaw with a mechanical brake mechanism in the related art after a side cover is removed according to another example.

FIG. 4 is a sectional view of a chainsaw in which an oil pump is not located between an electric motor and a guide plate according to an example.

FIG. 5 is a sectional view of a chainsaw in which an oil pump is located between an electric motor and a guide plate according to another example.

FIG. 6 is a plan view of a brake baffle, a tensioning operating member, and an illumination assembly of a chainsaw according to an example.

FIG. 7 is a schematic diagram of electric control of a chainsaw as an example of the present application.

FIG. 8 is a schematic diagram of electric control in which a controller in the chainsaw shown in FIG. 7 controls the chainsaw to brake in response to a braking instruction.

FIG. 9 is a flowchart of a control method for electric motor braking as an example of the present application.

FIG. 10A is a test waveform diagram of the braking duration and bus voltage of a chainsaw according to the present application.

FIG. 10B is a test waveform diagram of the braking duration and electric motor current of a chainsaw according to the present application.

FIG. 10C is a test waveform diagram of the braking duration and bus voltage of a chainsaw in the case of electric motor braking and energy recovery according to the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

Technical solutions proposed in the present application are described below in detail in conjunction with drawings and examples.

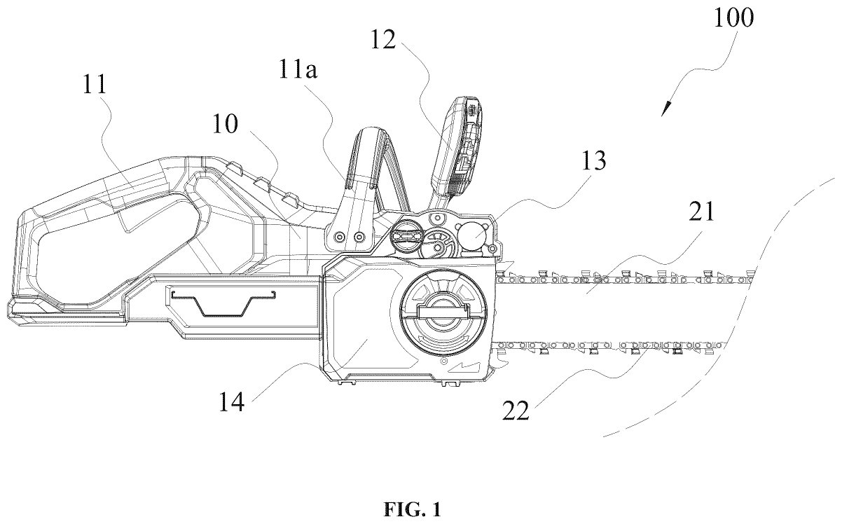

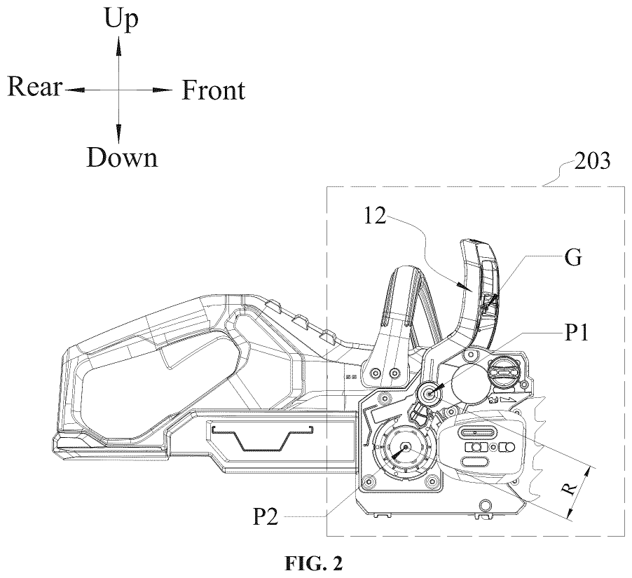

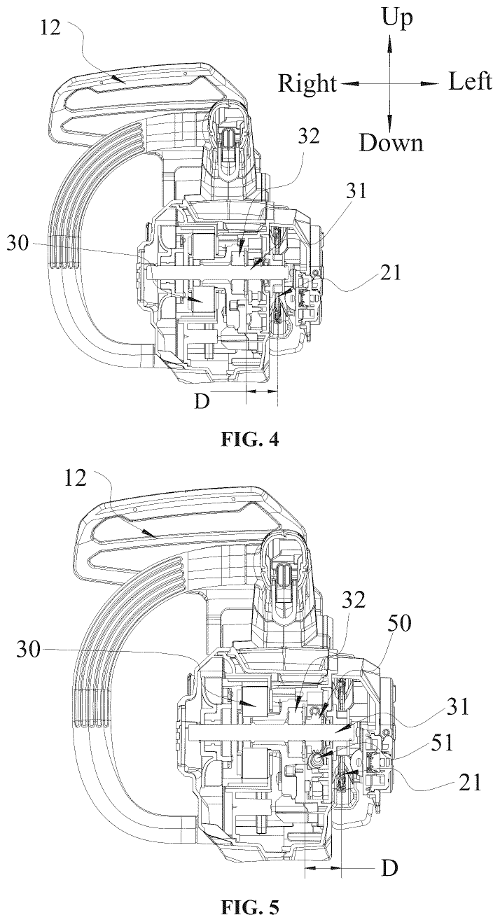

Referring to FIGS. 1 to 6, a chainsaw 100 as an example of the present application can be shown. The front, rear, left, right, upper, and lower sides of the chainsaw 100 in the present application are defined in FIGS. 2A and 4 and may be used as a reference for the orientation descriptions involved in some of the descriptions.

The chainsaw 100 includes a housing 10, an electric motor 30, a guide plate 21, and a chain 22. The housing 10 constitutes the appearance of the chainsaw 100, and an accommodation space is formed inside the housing 10. The housing 10 and the accommodation space inside the housing 10 can support, fix, and accommodate other components to be described later. The guide plate 21 is supported by the housing 10 and extends forward from the front end of the housing 10 to the outside of the housing 10. The chain 22 is a functional piece of the chainsaw 100 that actually performs cutting. The chain 22 surrounds the outer periphery of the guide plate 21 and is supported and guided by the guide plate 21. During working, the interlaced L-shaped blades on the chain 22 rotate around the outer periphery of the guide plate 21 along with the chain 22 to cut shrubs and the like.

The electric motor 30 is the prime mover of the chainsaw 100 and is accommodated in the accommodation space inside the housing 10. The electric motor 30 can convert electrical energy into mechanical energy for the rotation of a motor shaft 31 and then drive an output shaft directly or indirectly through a transmission assembly to rotate the chain 22 connected thereto, thereby performing cutting. The electric motor 30 includes a stator and a rotor that are nested. The electromagnetic induction between the stator and the rotor can achieve the energy conversion. The electric motor 30 further includes the motor shaft 31 and a motor bearing 32. The motor shaft 31 is connected to the rotor to rotate along with the rotor, and the motor bearing 32 supports, limits, and protects the motor shaft 31 and the rotor. In some examples, the electric motor 30 is a direct current motor. In some examples, the electric motor 30 is a permanent magnet motor. In some examples, the electric motor 30 is a brushless motor. In some examples, the electric motor 30 is a brushless direct current electric motor. In some examples, the electric motor 30 is a sensorless brushless direct current electric motor. In some other examples, the electric motor 30 may have a position sensor such as a Hall element to detect the position of the rotor, thereby assisting in the operation control of the electric motor 30. In some examples, the chainsaw 100 further includes a power supply device such as a battery pack 200 that can be detachably connected to a tool body. A portion for mounting the power supply device is usually formed on the housing 10. The battery pack 200 can supply electrical energy to at least the electric motor 30. Of course, components such as a control circuit 40 to be described later can also be powered by the battery pack 200.

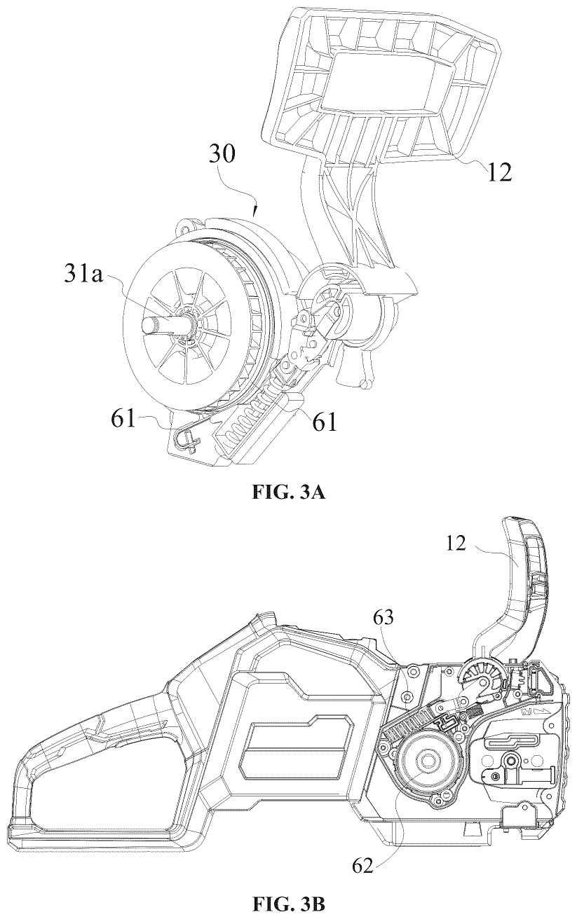

Based on the above, to ensure the safety and user experience of the user, the design of the braking function of the chainsaw is a key point. Currently, in the related art, as shown in FIGS. 3A and 3B, the chainsaw usually has a braking operating member such as a brake baffle and a mechanical brake mechanism connected to the braking operating member. The mechanical brake mechanism usually includes a brake disc 62 connected to the end of a chainsaw output shaft 31a and a brake steel belt 61 that is connected to the braking operating member 12 (for example, connected by a spring 63) and is adjacent to the outer circumference of the brake disc 62. After a brake baffle 12 is operated, the brake steel belt 61 extends toward the brake disc 62 and comes into contact with/fits/surrounds at least part of the outer circumference of the brake disc 62 so that the brake disc 62 is clamped, the movement of the brake disc 62 is restricted, and the brake disc 62 and the chainsaw output shaft 31a are braked by the friction and other forces between the brake disc 62 and the brake steel belt 61. Of course, the mechanical brake mechanisms shown in FIGS. 3A and 3B are only examples, and the complexity of the internal structures of the chainsaw is increased, making the chainsaw larger in dimension and weight, which is not conducive to user safety and experience. The structure with the brake steel belt and the brake disc is used as an example in which the cantilever of the motor shaft is lengthened and the vibration of the chainsaw is intensified.

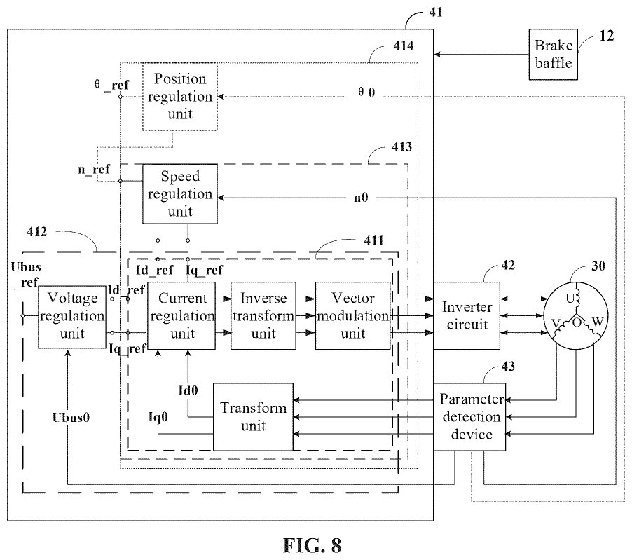

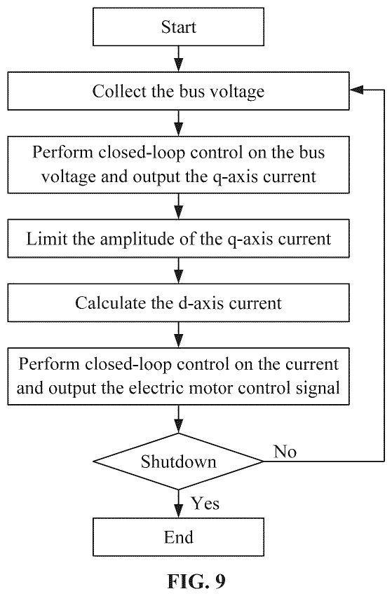

To solve the preceding technical problems, the chainsaw 100 in the present application includes the control circuit 40 in addition to the housing 10, the guide plate 21, the chain 22, and the electric motor 30. Referring to FIGS. 7 and 8, the control circuit 40 is connected between the battery pack 200 and the electric motor 30 and includes at least a controller 41 and an inverter circuit 42 having multiple switching elements 421. The controller 41 is configured to switch the conduction states of the switching elements 421 in the inverter circuit 42 to control the operation of the electric motor 30. Specifically, as shown in FIG. 7, the inverter circuit 42 is connected between the battery pack 200 and the electric motor 30 and is connected to the controller 41. The controller 41 may output different control signals to the inverter circuit 42. The conduction states of one or more switching elements 421 in the inverter circuit 42 change due to the variation of the control signals, and the conduction states of the switching elements 421 correspondingly affect the transfer of electrical energy from the battery pack 200 to the electric motor windings, thereby changing the magnetic field of the stator and the rotor of the electric motor and then achieving the operation control of the electric motor 30. In some examples, the controller 41 may be a microcontroller unit (MCU), an advanced reduced instruction set computing machine (ARM), or a general-purpose digital signal processor (DSP), which can run relevant programs and output control signals such as pulse-width modulation (PWM) signals to the inverter circuit 42. In some examples, the inverter circuit 42 is a three-phase bridge circuit, and the controller 41 may output signals to the six switching elements in the three-phase bridge circuit, respectively to adjust the magnitude and direction of the current in the electric motor windings. In some examples, the switching elements may be bipolar junction transistors (BJTs), metal-oxide semiconductor field-effect transistors (MOSFETs), or insulated-gate bipolar transistors (IGBTs).

In an optional example, the braking function of the chainsaw 100 in the present application is implemented by an electronic brake mechanism rather than a mechanical brake mechanism. The controller 41 in the control circuit 40 outputs a braking control signal in response to a braking instruction of the chainsaw 100 to control the state of the inverter circuit 42 so that the speed of the chain 22 of the chainsaw 100 is reduced from the operating chain speed to the braking chain speed, the maximum value of the operating chain speed of the chainsaw 100 is greater than or equal to 16 m/s, and the braking chain speed is less than or equal to 1 m/s. The operating chain speed and the braking chain speed are both the speeds at which the chain 22 rotates around the guide plate 21, the operating chain speed is the speed of the chain 22 when the chainsaw 100 is operating normally before braking is performed, and the braking chain speed is the speed at which active deceleration stops and passive deceleration starts after braking is performed, that is, the electronic brake mechanism operates at least before the chain speed drops to the braking chain speed. In some examples, the maximum value of the operating chain speed of the chainsaw 100 can be further increased to be greater than or equal to 20 m/s. This example aims to eliminate the mechanical brake in a high-speed chainsaw to reduce the dimension, weight, and cost and solve the vibration problem at a high chain speed.

In some examples, the braking instruction of the chainsaw 100 includes any one of a user operation instruction and a self-detection abnormality instruction. The user operation instruction is a braking instruction issued after the user operates the braking operating member such as the brake baffle and mainly reflects the user's subjective intention to brake the chainsaw 100. The chainsaw 100 self-detects motion-related parameters and/or electrical-related parameters to determine whether any abnormality exists in the motion state and/or electrical state, and the self-detection abnormality instruction is issued to the controller 41 after an abnormality occurs and mainly reflects that the chainsaw 100 automatically brakes due to the abnormality. For details about the chainsaw 100 self-detecting abnormalities to automatically trigger braking, reference is made to the records in Chinese Patent Application No. 202310803482.3 submitted by the applicant.

In some examples, the control circuit 40 includes a parameter detection device 43 in addition to the controller 41 and the inverter circuit 42. The parameter detection device 43 is configured to detect the working parameter of the electric motor 30, for example, to detect in real time one or more of the current working parameters of the electric motor 30 including, but not limited to, the current, the voltage, the torque, the power, and the rotor position. It is to be noted that the detection of the preceding various working parameters by the parameter detection device 43 may be either actual measurement by hardware or simulation and reconstruction by software. For example, an analog-to-digital converter (ADC) sampling circuit may be used to detect the current; and a Hall position sensor may be used to detect the rotor position, or the rotor position may be determined based on the back electromotive force observation method. Moreover, various working parameters may be measured or simulated, or various working parameters may be partially measured and partially simulated. There is no explicit limitation in the present application regarding the relevant content.

In some examples, the control circuit 40 of the chainsaw 100 controls the state of the inverter circuit 42 in the FOC manner or the vector control (VC) manner. Specifically, the control circuit 40 may set various levels of input parameters based on preset parameters and the working parameters measured by the parameter detection device 43 and regulate the output torque and/or output power and/or rotational speed of the electric motor 30 through the set input parameters, and the control circuit 40 can control the electric motor 30 to brake in response to the braking instruction. As shown in FIG. 8, the controller 41 may at least perform closed-loop negative feedback regulation, that is, current loop regulation, on the stator current of the electric motor 30 based on the Clarke transform, the inverse Clarke transform, the Park transform, and the inverse Park transform by using the working parameters of the electric motor 30 measured by the parameter detection device 43 so that the stator current of the electric motor 30 approaches and remains at a target value in a dynamically balanced manner. The preceding current loop is the basic component in the FOC manner. The actual three-phase currents Iu₀, Iv₀, and Iw₀ of the electric motor 30 may be measured by the parameter detection device 43 such as a current sampling circuit. Through the Clarke transform and the Park transform, the control circuit 40 may successively convert the actual three-phase currents from a three-phase stationary coordinate system to a two-phase stationary coordinate system to obtain Iao and Ibo and then convert the currents to a two-phase rotating coordinate system to obtain the d-axis actual current Ido and the q-axis actual current Iq₀. Moreover, based on the preset parameters such as the resistance, inductance, or other characteristic parameters of the electric motor, the control circuit 40 has obtained the d-axis target current Id_{ref} and the q-axis target current Iq_{ref}, and proportional-integral (PI) regulation or proportional-integral-derivative (PID) regulation is performed based on the difference between the d-axis actual current Id₀ and the corresponding d-axis target current Id_{ref} and the difference between the q-axis actual current Iq₀ and the corresponding q-axis target current Iq_{ref} to determine the d-axis voltage Udi and the q-axis voltage Uq₁ to be transmitted in the next cycle, the inverse Park transform and the inverse Clarke transform are performed, and finally, the three-phase voltages transmitted to the electric motor 30 in the next cycle are regulated to Uu₁, Uv₁, and Uw₁. In some examples, the transmission of the corresponding three-phase voltages to the electric motor 30 may be implemented by a vector modulation unit such as a space vector pulse-width modulation (SVPWM) unit.

In some examples, to achieve rapid braking of the chainsaw and improve energy utilization, in response to the braking instruction, the controller 41 switches the conduction states of the switching elements 421 in the inverter circuit 42 based on the rotor position and/or rotational speed to apply the braking torque that provides reverse acceleration to the electric motor 30, thereby achieving braking of the electric motor 30. During this braking process, a current flowing from the electric motor windings to the battery pack exists. During the electric motor braking, the mechanical energy can be at least partially converted into electrical energy and stored in the battery pack. It is to be noted that the braking torque provided by the control circuit 40 during braking directly affects the operating acceleration of the electric motor 30 and thus indirectly affects the operating speed of the electric motor 30, that is, the reverse acceleration is provided to cause the electric motor 30 to slow down and then brake, rather than directly achieving reverse rotation. For the same rotor position, the switching elements that are on during the normal operation of the electric motor are at least partially different from the switching elements that are on during braking. Moreover, the preceding action of the controller 41 switching the conduction states of the switching elements 421 when braking the chainsaw may not be performed once, for example, may be performed multiple times within a continuous period as the rotor position changes dynamically. In some examples, in the case where the control circuit 40 adopts the FOC manner, in response to the braking instruction, the q-axis target current Iq_{ref} and/or the d-axis target current Id_{ref} used in the current loop may be negative relative to the q-axis actual current Iq₀ and/or the d-axis actual current Id₀. Compared with the solution of directly performing three-phase short-circuiting in response to the braking instruction in the related art, the preceding example can avoid the energy waste problem caused by heat consumption of a large current in the stator windings during braking of the high-speed chainsaw. In some examples, the control circuit 40 may alternately adopt the preceding negative torque braking solution and the three-phase short-circuiting solution, thereby ensuring both safety and braking efficiency.

In some examples, the total duration of the braking process in which the controller 41 responds to the braking instruction to control the chain speed to reduce to zero is less than or equal to 120 ms. The braking process starts from the moment when the braking instruction is triggered and ends when the chain speed is reduced to zero. The total duration of the braking process is of great significance to the rapid braking of the high-speed chainsaw in the related art.

Based on the above, the negative torque braking generates feedback electrical energy flowing back to the battery pack during the braking process of the chainsaw. The higher the chain speed of the chainsaw is, the faster the braking rate is, the shorter the braking process is, the greater the power of the feedback electrical energy is, and the higher the possibility of the bus voltage overshooting between the battery pack and the electric motor is. Therefore, safety risks such as damage to the battery pack or even fire and explosion may be caused. This problem is particularly prominent when the maximum value of the operating chain speed of the chainsaw 100 in the present application exceeds 16 m/s and/or the duration of the braking process is less than or equal to 120 ms. In view of this, in an optional example, based on the fact that the control circuit 40 of the chainsaw 100 controls the operation of the electric motor 30 in the FOC manner, as shown in FIG. 8, an electric motor control solution for the preceding technical dilemma is proposed and has at least an inner current loop 411 and a voltage loop 412 outside the current loop 411. Specifically, in response to the braking instruction of the chainsaw, the controller 41 may perform closed-loop negative feedback regulation on the bus voltage of the electric motor 30 based on the current working parameters of the electric motor 30. As described above, the current loop 411 is the basic component of the FOC manner. In the related art, it is more common to add a speed loop 413 outside the current loop 411. The current loop 411 uses the target current and the actual current as input parameters of this loop and adopts PI regulation to obtain output parameters. The output parameters can regulate or indicate the magnitudes and directions of the subsequent three-phase voltages, while the speed loop 413 outside the current loop 411 may use the target rotational speed and the actual rotational speed as input parameters of this loop and also adopt PI regulation to obtain output parameters. Through the output parameters, the input parameter, that is, the target current of the subsequent current loop 411, may be directly or indirectly obtained. However, the preceding solution is not conducive to guiding the feedback electrical energy intensity during the braking control process. Therefore, in this example, during the braking process of the chainsaw 100, the voltage loop 412 is used to replace the speed loop 413 as the FOC outer loop, and the bus voltage is used as the negative feedback regulation target of the outer loop. In some examples, when the controller 41 performs closed-loop negative feedback regulation on the bus voltage between the battery pack 200 and the electric motor 30, one or more of the following boundary conditions may be satisfied, including, but not limited to: the target value of the bus voltage does not exceed the maximum value of the bus voltage allowed by hardware of the battery pack 200 and/or the electric motor 30; the current actual value of the bus voltage does not exceed the maximum value of the bus voltage allowed by hardware of the battery pack 200 and/or the electric motor 30; and the target value of the bus voltage is greater than or equal to the current actual value of the bus voltage. In this manner, based on the difference between the current actual value and the target value of the bus voltage in the voltage loop 412, the maximum negative torque current that can be currently adopted within the safety allowable range of the hardware of components is continuously and dynamically solved (for example, Iq_{ref}=−Kp·ΔUdc−Ki·ƒ(ΔUdc)dt, and ΔUdc=Udc_{ref}−Udc₀), and the input parameter is transmitted to the next-level FOC inner current loop 411, thereby avoiding the bus voltage overshooting during rapid braking and reverse charging and reducing the safety risks of the battery pack, the electric motor, and the chainsaw. In some examples, during the closed-loop negative feedback regulation process of the braking chainsaw 100 using the preceding solution, the numerical relationship between the maximum value of the bus voltage allowed by the hardware and the target value and the actual value of the bus voltage during regulation is mainly manifested in that the target value of the bus voltage is less than the maximum value of the bus voltage but greater than the actual value of the bus voltage. In some examples, the q-axis target current Iq_{ref} outputted by the voltage loop 412 is negative to provide negative torque for braking the rotor. Further, in some examples, the d-axis target current Id_{ref} of the input current loop 411 may also be negative to improve the bus voltage rise caused by reverse energy feedback. In some examples, when the controller 41 performs closed-loop negative feedback regulation on the current of the electric motor, one or more of the following boundary conditions may be satisfied, including, but not limited to: the target value of the bus current and/or the three-phase currents does not exceed the maximum value of the current allowed by hardware of the battery pack 200 and/or the electric motor 30; and the maximum value of the output power does not exceed the maximum value of the power allowed by at least one hardware among the battery pack 200, the electric motor 30, and the chainsaw 100. For example, the d-axis target current Id_{ref} of the input current loop 411 may be determined based on the q-axis target current Iq_{ref} and the current limit circle (Id_{ref}=−\sqrt{Imax²−Iqref²}). In some examples, the output of the voltage loop 412 is used as an intermediate parameter, and the maximum negative torque current calculated by the voltage loop 412 is adjusted under the constraints of the current limit, the power limit, and the limitation of the braking speed by a position sensorless vector control algorithm and then outputted to the current loop 411.

In some examples, as shown in FIG. 8, when the controller 41 in the chainsaw 100 controls the electric motor 30 to brake in the FOC manner, at least the current loop 411 as the inner loop and the voltage loop 412 as the outer loop are used; and when the controller 41 controls the electric motor 30 to operate normally in the FOC manner, at least the current loop 411 as the inner loop and the speed loop 413 as the outer loop are used. In some examples, the controller 41 uses the current loop 411, the speed loop 413, and a position loop 414 when controlling the electric motor 30 to operate normally in the FOC manner.

Correspondingly, the present application further provides a control method for electric motor braking. Referring to FIG. 9, this method adopts the FOC manner to control the electric motor. In response to the braking instruction, the outer loop of the current loop may be switched to the voltage loop, and the input parameter of the current loop is determined using the output of the voltage loop during the braking process. Specifically, as shown in FIG. 9, in response to the braking instruction, the following steps are periodically performed during the braking process: in the voltage loop, the q-axis target current Iq_{ref} in this cycle is calculated based on the target bus voltage and the actual bus voltage currently collected, the d-axis target current Id_{ref} in this cycle is calculated based on the q-axis target current Iq_{ref}, and the q-axis target current Iq_{ref} (or the q-axis target current Iq_{ref} and the d-axis target current Id_{ref}) is transmitted to the current loop and used as the input parameter; and in the current loop, the three-phase voltages to be transmitted in this cycle are calculated based on the q-axis target current Iq_{ref}, the d-axis target current Id_{ref}, and the actual three-phase currents of the electric motor currently collected. The steps are performed until the electric motor braking is completed. In some examples, the voltage loop calculation process satisfies one or more of the following boundary conditions, including, but not limited to: the target value of the bus voltage does not exceed the maximum value of the bus voltage allowed by hardware of the battery pack and/or the electric motor; the target value of the bus voltage is less than or equal to the current actual value of the bus voltage; the target value of the bus current and/or the three-phase currents does not exceed the maximum value of the current allowed by hardware (the battery pack and/or the electric motor); and the maximum value of the output power does not exceed the maximum value of the power allowed by at least one hardware among the battery pack, the electric motor, and the chainsaw.

In the preceding braking process, the solution in which the voltage loop is used to replace the speed loop as the outer loop of the current loop is adopted. In this manner, while rapid braking with negative torque can be achieved, closed-loop negative feedback regulation is performed on the bus voltage between the battery pack and the electric motor. In the current loop, the q-axis current value and the d-axis current value calculated in real time in the voltage loop are used as the target values, braking can be performed continuously and dynamically with the maximum negative torque current within the safety allowable range of hardware, chainsaw braking can be achieved smoothly along the numerical limit, and the bus voltage overshooting does not occur, thereby ensuring the safety of the battery pack, the electric motor, and the chainsaw.

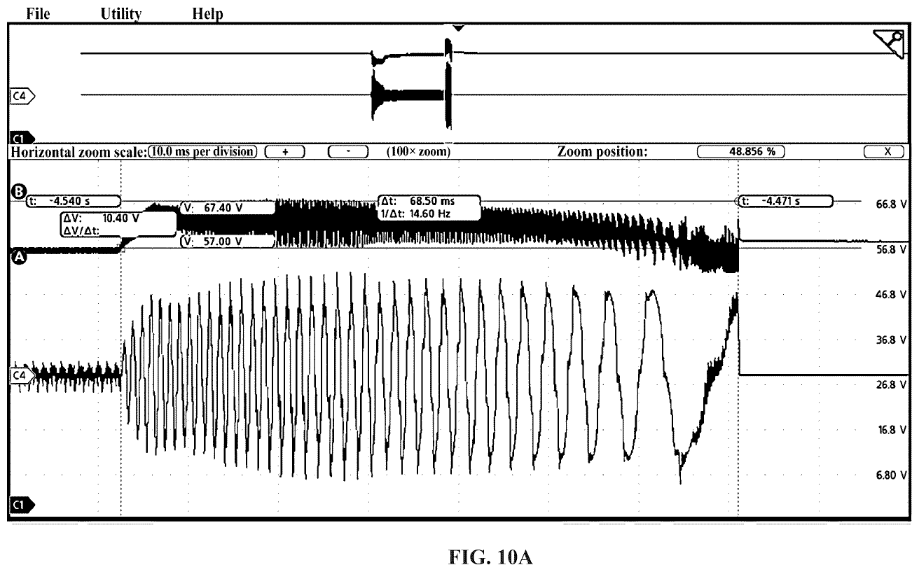

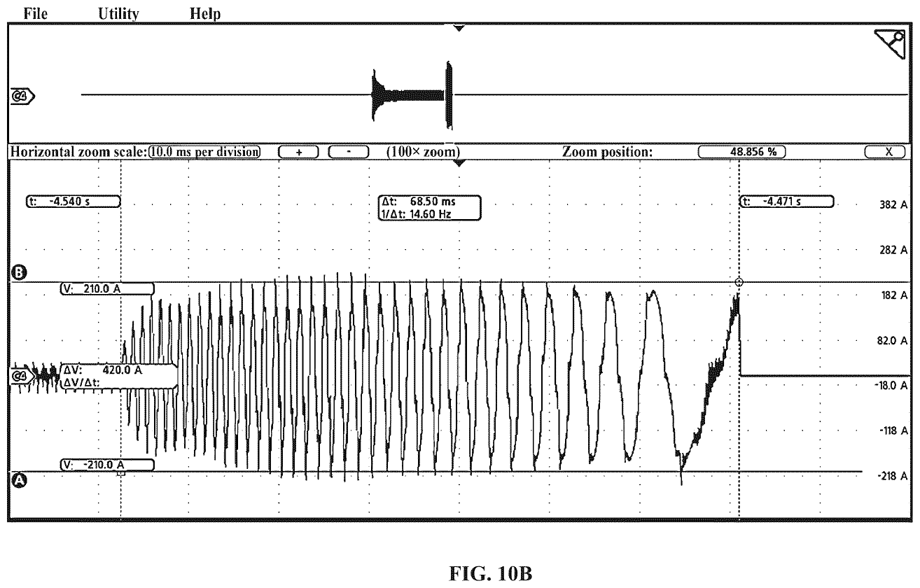

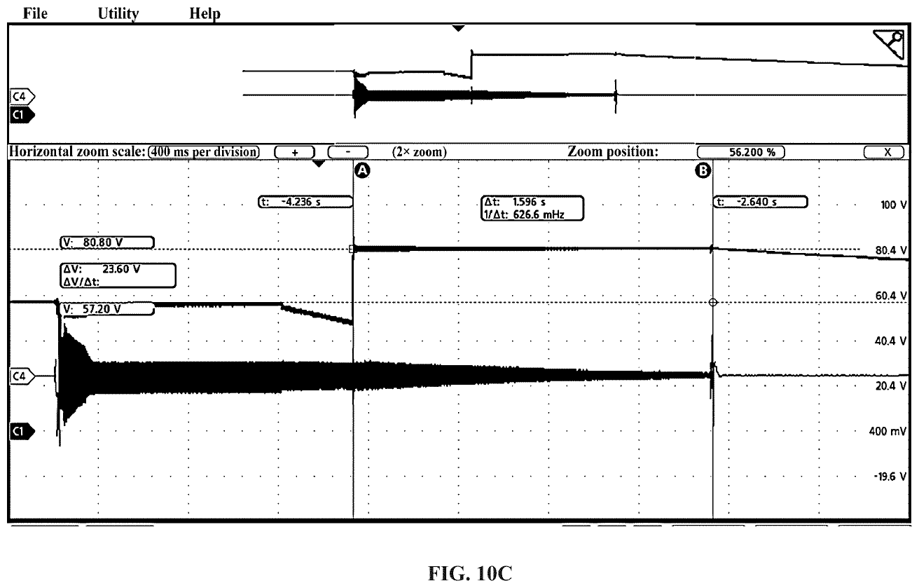

In some examples, as shown in FIG. 7, the control circuit 40 further includes an energy storage module 44 such as a large capacitor and/or a backup power supply. The energy storage module 44 may be connected in parallel with the battery pack 200 and between the battery pack 200 and the inverter circuit 42 and can collect and store the braking feedback electrical energy, thereby reducing the impact on the safety of the battery pack 200. In some examples, the battery pack may not participate in energy recovery during the braking process of the chainsaw, and the energy recovery may be achieved by the preceding energy storage module 44 in conjunction with the control circuit 40. However, if the bus voltage still needs to be kept within a safe range, as shown in FIG. 10C, the braking process of the chainsaw may be extended to more than 120 ms, so the three-phase short-circuiting solution may be adopted intermittently to shorten the braking duration.

Based on the above, the feedback electrical energy generated during the braking process of the chainsaw increases with the increase of the chain speed and the braking rate of the chainsaw. Reducing the possibility of the bus voltage overshooting between the battery pack and the electric motor is of great significance in the related art. In some examples, when the control circuit 40 controls the chainsaw to brake, the ratio of the maximum value of the bus voltage of the electric motor 30 during braking to the rated voltage of the battery pack 200 is less than or equal to 1.65, and/or the ratio of the maximum value of the bus voltage of the electric motor 30 during braking to the nominal voltage of the battery pack 200 is less than or equal to 1.5. Optionally, in some examples, the ratio of the maximum value of the bus voltage of the electric motor 30 during braking to the rated voltage of the battery pack 200 is less than or equal to 1.5, and/or the ratio of the maximum value of the bus voltage of the electric motor 30 during braking to the nominal voltage of the battery pack 200 is less than or equal to 1.35. Preferably, in some examples, the ratio of the maximum value of the bus voltage of the electric motor 30 during braking to the rated voltage of the battery pack 200 is less than or equal to 1.4, and/or the ratio of the maximum value of the bus voltage of the electric motor 30 during braking to the nominal voltage of the battery pack 200 is less than or equal to 1.3. Further, in some examples, the ratio of the maximum value of the bus voltage of the electric motor 30 during braking to the rated voltage of the battery pack 200 is less than or equal to 1.35, and/or the ratio of the maximum value of the bus voltage of the electric motor 30 during braking to the nominal voltage of the battery pack 200 is less than or equal to 1.25. As shown in FIGS. 10A and 10B, the braking duration of the chainsaw in the present application is approximately 68.5 ms, the peak value of the bus voltage of the electric motor is 67.4 V, the voltage rise value is 10.4 V, the braking current is 210 A, the battery pack is powered by 14 cells connected in series, the rated voltage of the cell is 3.6 V, the nominal voltage of the cell is 4 V, the rated voltage of the battery pack is 14*3.6 V, that is. 50.4 V, and the nominal voltage of the battery pack is 14*4 V, that is. 56 V. During the braking process of the chainsaw, the ratio of the maximum value of the bus voltage of the electric motor to the rated voltage of the battery pack is 1.337, and the ratio of the maximum value of the bus voltage of the electric motor to the nominal voltage of the battery pack is 1.204. The preceding ratios when the chainsaw is powered by other types of battery packs can also be calculated with reference to the method described above.

In another optional example, the braking function of the chainsaw 100 is implemented by an electronic brake mechanism rather than a mechanical brake mechanism. The controller 41 in the control circuit 40 outputs the braking control signal in response to the braking instruction of the chainsaw to control the state of the inverter circuit 42, thereby braking the chainsaw within 120 ms. Moreover, the maximum value of the operating chain speed of the chainsaw 100 is greater than or equal to 16 m/s. Braking the chainsaw within 120 ms means that the chain speed of the chainsaw 100 can be reduced from the operating chain speed to zero within 120 ms from the moment when the braking instruction is issued, for example, from the moment when the user operates the brake baffle to brake the chainsaw. In some examples, the maximum value of the operating chain speed of the chainsaw 100 can be further increased to be greater than or equal to 20 m/s. This example aims to eliminate the mechanical brake mechanism in a high-speed chainsaw to reduce the dimension, weight, and cost and reduce the vibration at a high speed.

It is to be noted that in the preceding multiple examples, the chainsaw 100 may rely solely on the controller 41 to brake the electric motor 30 in response to the braking instruction so that the speed of the chain 22 can be quickly reduced from the operating chain speed to the braking chain speed. No mechanical brake mechanism is provided in the chainsaw 100, that is, structures such as the brake disc and the brake steel belt are not provided, thereby reducing the vibration of the high-speed chainsaw and optimizing the dimension and weight.

Correspondingly, based on the above, in an optional example, in addition to the housing 10, the guide plate 21, the chain 22, and the electric motor 30, the chainsaw 100 includes the control circuit 40 having the controller 41 and the inverter circuit 42. The controller 41 switches the conduction states of the switching elements 421 in the inverter circuit 42 to control the electric motor 30 to operate in the intended manner. In response to the braking instruction, the control circuit 40 outputs the braking control signal to control the state of the inverter circuit 42, thereby braking the electric motor 30 within 120 ms. The ratio of the maximum value of the bus voltage of the electric motor 30 during braking to the rated voltage of the battery pack 200 is less than or equal to 1.65, and/or the ratio of the maximum value of the bus voltage of the electric motor 30 during braking to the nominal voltage of the battery pack 200 is less than or equal to 1.5. Preferably, in some examples, the ratio of the maximum value of the bus voltage of the electric motor 30 during braking to the rated voltage of the battery pack 200 is less than or equal to 1.4, and/or the ratio of the maximum value of the bus voltage of the electric motor 30 during braking to the nominal voltage of the battery pack 200 is less than or equal to 1.3. In another optional example, the maximum value of the operating chain speed of the chainsaw 100 is greater than or equal to 16 m/s. The controller 41 outputs the braking control signal in response to the braking instruction to control the state of the inverter circuit 42, thereby braking the electric motor 30. The ratio of the maximum value of the bus voltage of the electric motor 30 during braking to the rated voltage of the battery pack 200 is less than or equal to 1.65, and/or the ratio of the maximum value of the bus voltage of the electric motor 30 during braking to the nominal voltage of the battery pack 200 is less than or equal to 1.5. Preferably, in some examples, the ratio of the maximum value of the bus voltage of the electric motor 30 during braking to the rated voltage of the battery pack 200 is less than or equal to 1.4, and/or the ratio of the maximum value of the bus voltage of the electric motor 30 during braking to the nominal voltage of the battery pack 200 is less than or equal to 1.3. In this example, the chainsaw 100 may or may not have a mechanical brake mechanism.

In addition, in an optional example, as shown in FIG. 4, the chainsaw 100 includes the housing 10, the guide plate 21, the chain 22, and the electric motor 30. The electric motor 30 has a stator and a rotor that are nested and further includes the motor shaft 31 that extends axially at the radial center of the electric motor 30 and is connected to the rotor to rotate about the axis and one or more motor bearings 32 that are sleeved on the motor shaft 31 and can ensure the operation stability of the electric motor. The one or more motor bearings 32 include at least one motor bearing 32 that is adjacent to the guide plate and may be located between the guide plate 21 and the stator and rotor of the electric motor 30. Through the reasonable adjustment of the structural arrangement and the optimization of the brake mechanism, along the axial direction of the motor shaft 31, the distance D between the motor bearing 32 adjacent to the guide plate and the plane where the guide plate 21 is located is less than or equal to 18 mm. In some examples, preferably, the distance D between the motor bearing 32 adjacent to the guide plate and the plane where the guide plate 21 is located may be less than or equal to 12 mm. In another optional example, the minimum value of the distance D between the motor bearing 32 and the plane where the guide plate 21 is located, that is, the distance D between the motor bearing 32 closest to the guide plate 21 and the plane where the guide plate 21 is located, is less than or equal to 18 mm, preferably, less than or equal to 12 mm.

In some examples, the chainsaw 100 does not have an oil pump 51 or the oil pump 51 in an oil pump assembly 50 is not between the guide plate 21 and the electric motor 30 so that the width of the housing of the chainsaw 100 in the left and right direction can be reduced, and the related structure can be more compact.

In some examples, the electric motor 30 in the preceding chainsaw 100 drives the chain 22 in a direct drive mode, and the motor shaft 31 can directly drive the sprocket to rotate without the need for transmission through other components. Therefore, the relevant structures in the chainsaw can be simplified. However, a challenge to the cantilever length of the motor shaft and the related vibration problem is posed. In some examples, the preceding chainsaw 100 does not have a mechanical brake mechanism, and the braking of the chainsaw 100 is achieved by relying solely on an electronic brake mechanism, thereby shortening the relevant dimensions by eliminating the brake steel belt, the brake disc, and the like.

In some examples, the chainsaw 100 further includes the brake baffle 12 rotatably connected to the housing 10. The brake baffle 12 is both a braking operating member for the user to operate to brake the chainsaw and a front handle guard 12 located in front of a main handle 11 and/or a side handle 11a of the chainsaw 100. The front handle guard 12 can protect the user's hand holding the main handle 11 from being accidentally injured by the chain 22. During braking, the brake baffle 12 is pulled to rotate relative to the housing 10 to trigger the stop of the chain 22. In some examples, as shown in FIGS. 2A and 2B, a first plane perpendicular to the rotation axis of the rotor is defined, that is, a first plane perpendicular to the axis of the motor shaft is defined, and the distance R between the projection of the rotation axis of the brake baffle 12 on the first plane and the projection of the rotation axis of the motor shaft 31 or the rotor on the first plane is less than or equal to 55 mm. In some examples, the distance R between the point of intersection between the axis of the motor shaft 31 and the first plane and the point of intersection between the rotation axis of the brake baffle 12 and the first plane is less than or equal to 55 mm. In some examples, the rotation axis of the motor shaft 31 or the rotor and the rotation axis of the brake baffle 12 are parallel to each other and are both perpendicular to the first plane. When the distance between the center of rotation of the brake baffle 12 and the center of rotation of the motor shaft 31 decreases, the distance between the center of gravity of the brake baffle 12 and the center of rotation increases, and the moment of inertia of the brake baffle 12 increases, thereby ensuring more convenient user operation and a better experience. In some examples, the mass of the brake baffle 12 is less than or equal to 70 g to improve the experience when the user operates the braking operating member and reduce the overall weight. The moment of inertia of the brake baffle 12 can be maintained or optimized by adjusting the position of the center of gravity or the center of rotation.

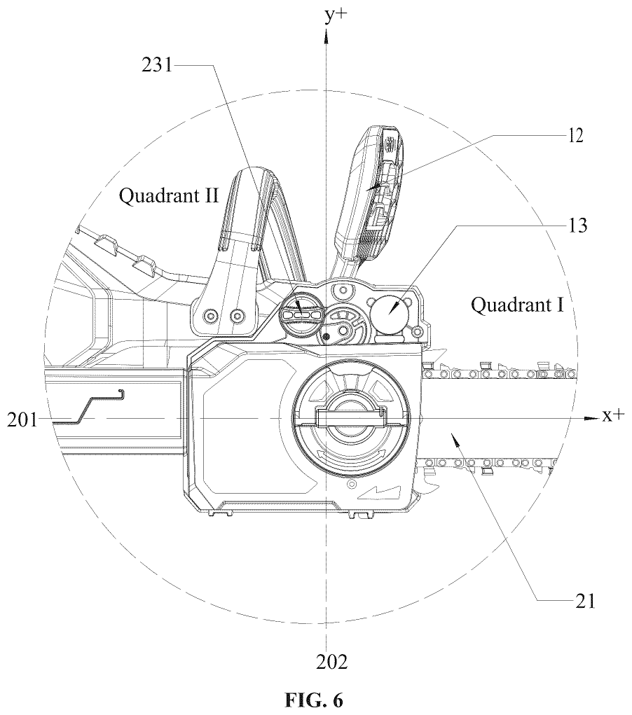

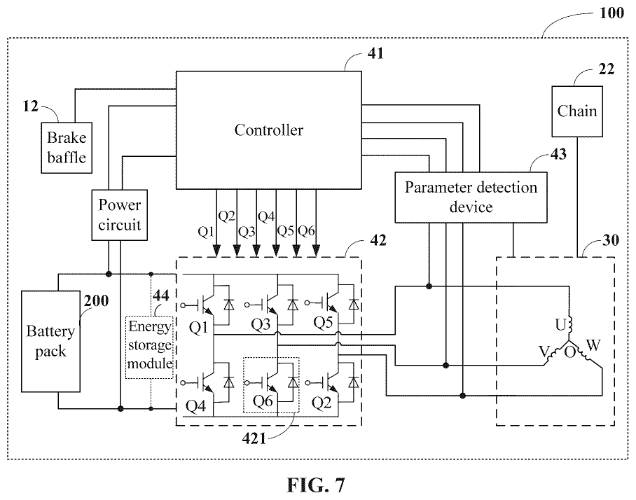

In some examples, the chainsaw 100 further includes a tensioning assembly 23. The tensioning assembly 23, the guide plate 21, and the chain 22 are mounted between a main housing and a side cover 14. The tensioning assembly 23 includes a tensioning operating member 231 that is disposed on the housing 10 and operable by the user to adjust the tension of the chain 22 around the outer periphery of the guide plate 21. For example, the tensioning operating member 231 may be a tensioning knob. By rotating the tensioning knob in the forward or reverse direction, the guide plate 21 can be moved forward or backward to tighten or loosen the chain 22 on the guide plate 21. The mechanism that actually achieves the tensioning of the chain 22 in the tensioning assembly 23 has multiple selectable structural compositions, and no specific restrictions are made here. In some examples, as shown in FIG. 6, a two-dimensional coordinate system (a plane coordinate system) is defined in the plane where the guide plate 21 is located, a guide plate centerline 201 is used as the horizontal coordinate axis (x-axis) of the coordinate system, the forward direction of the guide plate 21 extending out of the housing 10 is used as the positive direction of the x-axis, a vertical line perpendicular to the guide plate centerline 201 and passing through the projection of the rotation axis of the brake baffle 12 on the plane where the guide plate 21 is located is determined as the vertical coordinate axis (y-axis) of the coordinate system, and the upward direction along which the main handle 11 is located relative to the main housing is the positive direction of the y-axis. The projection of the tensioning operating member 231 of the tensioning assembly 23 on the plane where the guide plate 21 is located falls into the second quadrant of the coordinate system, that is, the tensioning operating member 231 may be mapped to the negative half-axis of the x-axis and the positive half-axis of the y-axis. In some examples, in the front and rear direction, the tensioning operating member 231 is at least partially located behind the brake baffle 12. In some examples, an illumination assembly 13 is additionally mounted on the housing 10 of the chainsaw 100, and the projection of the illumination assembly 13 on the plane where the guide plate 21 is located falls into the first quadrant of the preceding coordinate system, that is, the illumination assembly 13 such as the light bead on the housing 10 may be mapped to the positive half-axis of the x-axis and the positive half-axis of the y-axis. Compared with the related art in which the tensioning knob is restricted to be located in the first quadrant of the coordinate system due to structural limitations, in the manner in which the mechanical brake mechanism is eliminated, the position of the tensioning knob can be arranged more flexibly to make room for other components.

In another optional example, as shown in FIG. 5, the chainsaw 100 includes the housing 10, the guide plate 21, the chain 22, and the electric motor 30. The electric motor 30 includes the motor shaft 31, the stator, the rotor, and the motor bearing 32. Moreover, the chainsaw 100 further includes the oil pump assembly 50 at least partially disposed on a side of the motor bearing 32 facing the guide plate 21. In some examples, the oil pump 51 in the oil pump assembly 50 is disposed between the guide plate 21 and the electric motor 30, for example, between the guide plate 21 and the motor bearing 32 adjacent to the guide plate. Along the axial direction of the motor shaft 31, the distance D between the motor bearing 32 adjacent to the guide plate and the plane where the guide plate 21 is located is less than or equal to 30 mm. In some examples, preferably, the distance D between the motor bearing 32 adjacent to the guide plate and the plane where the guide plate 21 is located is less than or equal to 24 mm. In another optional example, the minimum value of the distance D between the motor bearing 32 and the plane where the guide plate 21 is located, that is, the distance D between the motor bearing 32 closest to the guide plate 21 and the plane where the guide plate 21 is located, is less than or equal to 30 mm, preferably, less than or equal to 24 mm. Compared with the preceding example, since the oil pump assembly 50 is at least partially disposed between the guide plate 21 and the electric motor 30, the distance between the motor bearing 32 and the guide plate 21 is affected, and the relevant dimensions are relatively increased. However, this example still has advantages over the related art.

The technical effects of the present application include at least the following: the entire chainsaw or the power mechanism can be more compact and lightweight, the vibration and noise are reduced, and the operation stability, the operating feeling, and the service life can be improved. It is to be understood that, under the premise that the features of the solutions do not conflict with each other, multiple examples in multiple implementations described above can be cross-combined with each other to comprehensively optimize and improve the chainsaw in the present application.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A chainsaw, comprising:
a housing;
an electric motor supported by the housing;
a chain driven by the electric motor to perform cutting;
a guide plate for supporting and guiding the chain; and
a control circuit comprising an inverter circuit having a plurality of switching elements and a controller configured to switch conduction states of the plurality of switching elements in the inverter circuit to control operation of the electric motor;
wherein the controller outputs a braking control signal in response to a braking instruction to control a state of the inverter circuit so that a speed of the chain is reduced from an operating chain speed to a braking chain speed, a maximum value of the operating chain speed is greater than or equal to 16 m/s, and the braking chain speed is less than or equal to 1 m/s.

2. The chainsaw of claim 1, wherein the maximum value of the operating chain speed is greater than or equal to 20 m/s.

3. The chainsaw of claim 1, wherein a braking duration of the chainsaw is less than or equal to 120 ms.

4. The chainsaw of claim 1, further comprising a battery pack for supplying power to at least the electric motor, wherein during a braking process of the chainsaw, a maximum value of a bus voltage of the electric motor does not exceed 1.65 times a rated voltage of the battery pack, and/or during a braking process of the chainsaw, a maximum value of a bus voltage of the electric motor does not exceed 1.5 times a nominal voltage of the battery pack.

5. The chainsaw of claim 1, further comprising a battery pack for supplying power to at least the electric motor, wherein during a braking process of the chainsaw, a maximum value of a bus voltage of the electric motor does not exceed 1.4 times a rated voltage of the battery pack, and/or during a braking process of the chainsaw, a maximum value of a bus voltage of the electric motor does not exceed 1.3 times a nominal voltage of the battery pack.

6. The chainsaw of claim 1, wherein the chainsaw does not have a mechanical brake mechanism.

7. The chainsaw of claim 1, wherein the braking instruction comprises a user operation instruction and a self-detection abnormality instruction.

8. The chainsaw of claim 1, wherein the electric motor is a brushless motor, and the controller controls the state of the inverter circuit in a field-oriented control (FOC) manner.

9. The chainsaw of claim 8, wherein, when the controller controls the electric motor to brake in the FOC manner, a quadrature-axis (q-axis) target current is set to a negative value relative to a q-axis actual current, and/or a direct-axis (d-axis) target current is set to a negative value relative to a d-axis actual current.

10. The chainsaw of claim 8, wherein the control circuit further comprises a parameter detection device configured to detect a working parameter of the electric motor, and the controller performs closed-loop negative feedback regulation on a bus voltage of the electric motor based on the current working parameter of the electric motor in response to the braking instruction.

11. The chainsaw of claim 10, wherein, when the controller performs the closed-loop negative feedback regulation on the bus voltage of the electric motor, at least one of the following boundary conditions is satisfied: a target value of the bus voltage does not exceed a maximum value of the bus voltage allowed by hardware of a battery pack and/or the electric motor; a current actual value of the bus voltage does not exceed a maximum value of the bus voltage allowed by hardware of a battery pack and/or the electric motor; and a target value of the bus voltage is greater than or equal to a current actual value of the bus voltage.

12. The chainsaw of claim 8, wherein, when the controller controls the electric motor to operate normally in the FOC manner, at least a current loop as an inner loop and a speed loop as an outer loop are used, and, when the controller controls the electric motor to brake in the FOC manner, at least the current loop as the inner loop and a voltage loop as an outer loop are used.

13. The chainsaw of claim 12, wherein when the controller performs closed-loop negative feedback regulation on a current of the electric motor, at least one of the following boundary conditions is satisfied: a target value of a bus current and/or a three-phase current does not exceed a maximum value of the current allowed by hardware of a battery pack and/or the electric motor; and a maximum value of output power does not exceed a maximum value of power allowed by at least one hardware among a battery pack, the electric motor, and the chainsaw.

14. The chainsaw of claim 1, further comprising a brake baffle rotatably connected to the housing, wherein a mass of the brake baffle is less than or equal to 70 g.

15. The chainsaw of claim 14, wherein a distance between a projection of a rotation axis of the brake baffle on a first plane and a projection of a rotation axis of a motor shaft of the electric motor on the first plane is less than or equal to 55 mm, and the first plane is perpendicular to the rotation axis of the motor shaft.

16. A chainsaw, comprising:
a housing;
an electric motor supported by the housing;
a chain driven by the electric motor to perform cutting;
a guide plate for supporting and guiding the chain; and
a control circuit comprising an inverter circuit having a plurality of switching elements and a controller configured to switch conduction states of the plurality of switching elements in the inverter circuit to control operation of the electric motor;
wherein the controller outputs a braking control signal in response to a braking instruction to control a state of the inverter circuit so that the chainsaw is braked within 120 ms, and a maximum value of an operating chain speed of the chain is greater than or equal to 16 m/s.

17. The chainsaw of claim 16, wherein the electric motor comprises a motor shaft and a motor bearing sleeved on the motor shaft, wherein along an axial direction of the motor shaft, a distance from the motor bearing adjacent to the guide plate to a plane where the guide plate is located is less than or equal to 18 mm, and the chainsaw does not have an oil pump or an oil pump in an oil pump assembly is not between the guide plate and the motor bearing.

18. The chainsaw of claim 16, wherein the electric motor comprises a motor shaft and a motor bearing sleeved on the motor shaft, wherein along an axial direction of the motor shaft, a distance from the motor bearing adjacent to the guide plate to a plane where the guide plate is located is less than or equal to 30 mm, and an oil pump assembly of the chainsaw is at least partially disposed on a side of the motor bearing facing the guide plate.

19. The chainsaw of claim 16, further comprising a brake baffle and a tensioning assembly, wherein the brake baffle is rotatably connected to the housing, and the tensioning assembly comprises a tensioning operating member operable by a user to adjust tension of the chain around an outer periphery of the guide plate; and a guide plate centerline is used as a horizontal coordinate axis, a projection of a rotation axis of the brake baffle on a plane where the guide plate is located is defined as a vertical coordinate axis, and the tensioning operating member is located in a second quadrant of a coordinate system formed by the horizontal coordinate axis and the vertical coordinate axis.

20. A chainsaw, comprising:
a housing;
an electric motor supported by the housing;
a battery pack for supplying power to at least the electric motor;
a chain driven by the electric motor to perform cutting;
a guide plate for supporting and guiding the chain; and
a control circuit comprising an inverter circuit having a plurality of switching elements and a controller configured to switch conduction states of the plurality of switching elements in the inverter circuit to control operation of the electric motor;
wherein the control circuit outputs a braking control signal in response to a braking instruction to control a state of the inverter circuit so that the chainsaw is braked within 120 ms;
and a ratio of a maximum value of a bus voltage of the electric motor during braking to a rated voltage of the battery pack is less than or equal to 1.65, and/or a ratio of a maximum value of a bus voltage of the electric motor during braking to a nominal voltage of the battery pack is less than or equal to 1.5.
